(19) United States
(12) Patent Application Publication
(10) Pub. No.: US 2006/0167853 A1
(43) Pub. Date: Jul. 27, 2006

(54) Content searching method, system, program product and architecture

(75) Inventors: Marsha R. Cohen, Indianapolis, IN (US); Jean B. Craig, Mount Pleasant, SC (US); John M. Higdon, Lexington, KY (US); Paul J. Kirkwood, Nicholasville, KY (US); Tina M. Lemire, Lexington, KY (US); Ross A. Mikosh, Austin, TX (US); Terry D. Pitts, Bakersfield, CA (US); Anthony P. Scherk, Midway, KY (US); Mary Louise Snedden, San Carlos, CA (US)

Correspondence Address: HOFFMAN, WARNICK & D'ALESSANDRO LLC, 75 STATE ST, 14TH FLOOR, ALBANY, NY, 12207, US

(73) Assignee: International Business Machines Corporation, Armonk, NY (US)

(21) Appl. No.: 11/046,595

(22) Filed: Jan. 27, 2005

(51) Int. Cl. G06F 7/00

(52) U.S. Cl. 707/3

(57) ABSTRACT

Under the present invention, searchable content is loaded into a search engine database, while displayable content is stored in a file system (e.g., in an XML file or the like) that is architecturally separate from the search engine database. Searchable content is associated with corresponding displayable content through links/pointers. In addition, tags for formatting the displayable content are provided in a style sheet or the like that is referenced by the displayable content file. When a search request for one or more search items is received by the search engine, the searchable content in the database will be searched. When appropriate searchable content is located, the corresponding displayable content will be located through the links. Once located, the displayable content will be formatted according to formatting tags contained in the associated style sheet. After formatting, the displayable content will then be presented to the user.

### BACKGROUND OF THE INVENTION

1. Field of the Invention

In general, the present invention provides a content searching method, system, program product and architecture. Specifically, the present invention allows for searchable content to be architecturally separated from corresponding displayable content as well as associated formatting tags, thus allowing for faster, more efficient content searching.

2. Related Art

As the use of computer networks such as the Internet becomes more pervasive, search engines have become a valuable tool in locating needed content. For example, today a computer user can utilize a search engine to locate needed goods/services, perform research, and find solutions to various problems/issues. Currently, it is the practice for a search engine database to include both searchable content and displayable content. For example, troubleshooting solutions, which include problem statements and fixes, are loaded into the search engine database. The content is broken down into searchable items which are searched to fulfill a search request/query, and displayable items which are presented when corresponding searchable items are located. To this extent, the searchable content is typically a pared down, unformatted version of the displayable content. That is, since only a small part of the displayable content is needed for searching, the searchable content will generally include only the bare content that might be the target of a user's search request. Conversely, the corresponding displayable content will include all content and formatting that is desired to be presented to the user. For example, when a search request is submitted pursuant to a problem the user is attempting to troubleshoot, the displayable content might not only include a statement of the problem and the possible solution(s), but also other items such as related documents, a feedback mechanism, advertisements, etc.

Unfortunately, the co-location of searchable content and displayable content in the search engine database raises many issues. For example, loading both types of content in the search engine database increases the volume of material therein. As a result, the speed at which searches are handled is reduced. However, no existing system provides a way of architecturally separating searchable content from displayable content so that a search engine database can be more rapidly searched. Providing such separation would greatly improve search engine performance.

In view of the foregoing, there exists a need for an improved content searching method, system, program product and architecture. Specifically, a need exists for an architecture in which searchable content is architecturally separated from displayable content and associated formatting characteristics.

### SUMMARY OF THE INVENTION

In general, the present invention provides a content searching method, system, program product and architecture. Specifically, under the present invention, searchable content is loaded into a search engine database, while displayable content is stored in a file system (e.g., in an XML file or the like) that is architecturally separate from the search engine database. Searchable content is associated with corresponding displayable content through links/pointers. In addition, tags for formatting the displayable content are provided in a style sheet or the like that is referenced by the displayable content file. When a search request for one or more search items is received by the search engine, the searchable content in the database will be searched. When appropriate searchable content is located, the corresponding displayable content will be located through the links. Once located, the displayable content will be formatted according to formatting tags contained in the associated style sheet. After formatting, the displayable content will then be presented to the user.

A first aspect of the present invention provides a content searching method, comprising: loading searchable content into a search engine; storing displayable content corresponding to the searchable content in a file system that is separate from the search engine, wherein the searchable content loaded into the search engine includes at least one link pointing to the displayable content in the file system; and providing formatting tags for formatting the displayable content in a style sheet.

A second aspect of the present invention provides a content searching architecture, comprising: a search engine having searchable content corresponding to searchable items; a file system separate from the search engine having displayable content corresponding to the searchable content, wherein the searchable content is associated with the displayable by at least one link; and a style sheet containing formatting tags for formatting the displayable content.

A third aspect of the present invention provides a content searching system, comprising: a searchable content location system for locating searchable content in a search engine database based on a search request; a displayable content location system for locating displayable content corresponding to the searchable content in a file system based on at least one link that associates the searchable content with the displayable content, wherein the file system is separate from the search engine database; a content formatting system for formatting the displayable content based on formatting tags contained in a style sheet associated with the displayable content; and an output system for outputting the displayable content after the formatting.

A fourth aspect of the present invention provides a content searching program product stored on a recordable medium, which when executed, comprises: program code for locating searchable content in a search engine database based on a search request; program code for locating displayable content corresponding to the searchable content in a file system based on at least one link that associates the searchable content with the displayable content, wherein the file system is separate from the search engine database; program code for formatting the displayable content based on formatting tags contained in a style sheet associated with the displayable content; and program code for outputting the displayable content after the formatting.

A fifth aspect of the present invention provides a system for deploying a content searching application, comprising: a computer infrastructure being operable to: locate searchable content in a search engine database based on a search request; locate displayable content corresponding to the searchable content in a file system based on at least one link that associates the searchable content with the displayable content, wherein the file system is separate from the search engine database; format the displayable content based on formatting tags contained in a style sheet associated with the displayable content; and output the displayable content after the formatting.

A sixth aspect of the present invention provides content searching computer software embodied in a propagated signal, the content searching computer software comprising instructions for causing a computer system to perform the following functions: locate searchable content in a search engine database based on a search request; locate displayable content corresponding to the searchable content in a file system based on at least one link that associates the searchable content with the displayable content, wherein the file system is separate from the search engine database; format the displayable content based on formatting tags contained in a style sheet associated with the displayable content; and output the displayable content after the formatting.

Therefore, the present invention provides a content searching method, system, program product and architecture.

### BRIEF DESCRIPTION OF THE DRAWINGS

These and other features of this invention will be more readily understood from the following detailed description of the various aspects of the invention taken in conjunction with the accompanying drawings in which:

FIG. 1 depicts a content search architecture according to the present invention.

FIG. 2 depicts an illustrative screen shot depicting displayable content.

FIG. 3 depicts an illustrative screen shot depicting searchable content.

FIG. 4 depicts a more specific computerized implementation of the architecture of FIG. 1.

The drawings are not necessarily to scale. The drawings are merely schematic representations, not intended to portray specific parameters of the invention. The drawings are intended to depict only typical embodiments of the invention, and therefore should not be considered as limiting the scope of the invention. In the drawings, like numbering represents like elements.

### DETAILED DESCRIPTION OF THE DRAWINGS

For convenience purposes, the Detailed Description of the Drawings will have the following sections:

I. General Description

II. Computerized Implementation

I. General Description

As indicated above, the present invention provides a content searching method, system, program product and architecture. Specifically, under the present invention, searchable content is loaded into a search engine database, while displayable content is stored in a file system (e.g., in an XML file or the like) that is architecturally separate from the search engine database. Searchable content is associated with corresponding displayable content through links/pointers. In addition, tags for formatting the displayable content are provided in a style sheet or the like that is referenced by the displayable content file. When a search request for one or more search items is received by the search engine, the searchable content in the database will be searched. When appropriate searchable content is located, the corresponding displayable content will be located through the links. Once located, the displayable content will be formatted according to formatting tags contained in the associated style sheet. After formatting, the displayable content will then be presented to the user.

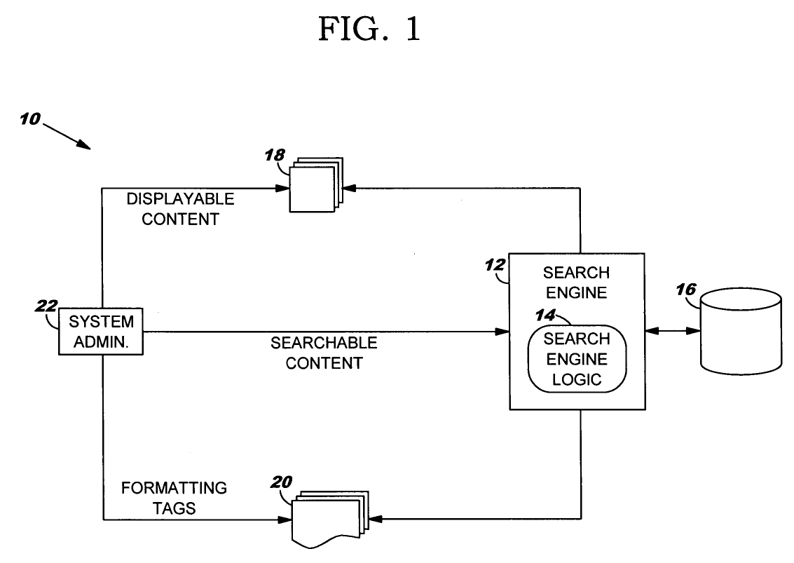

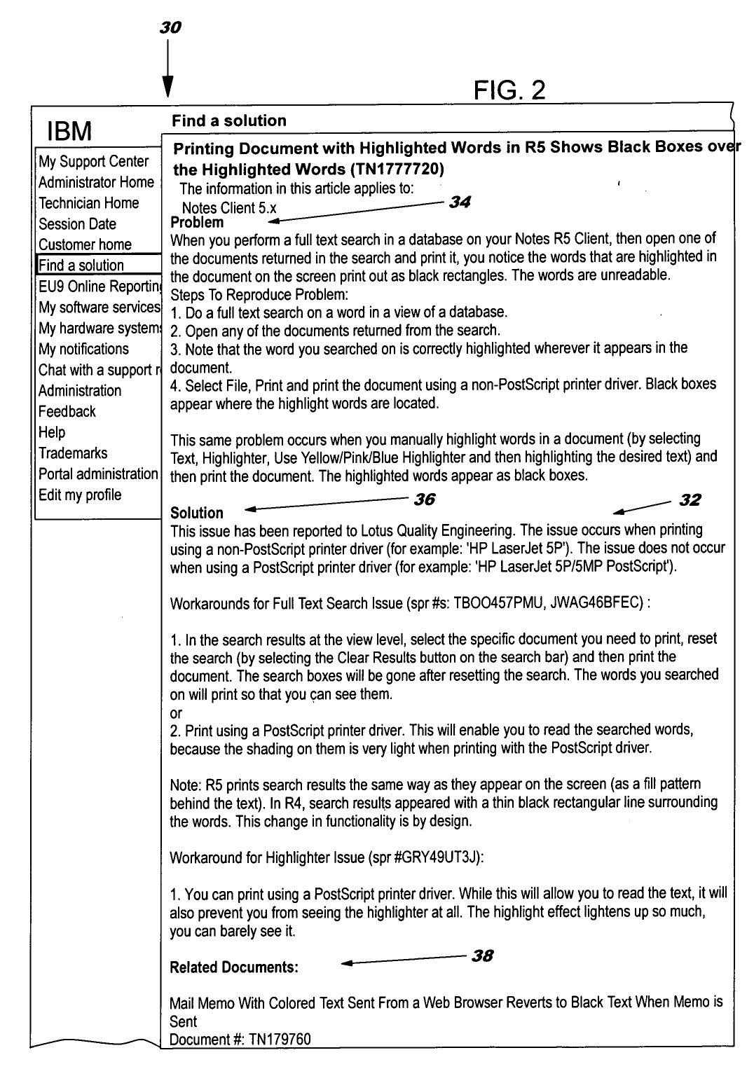

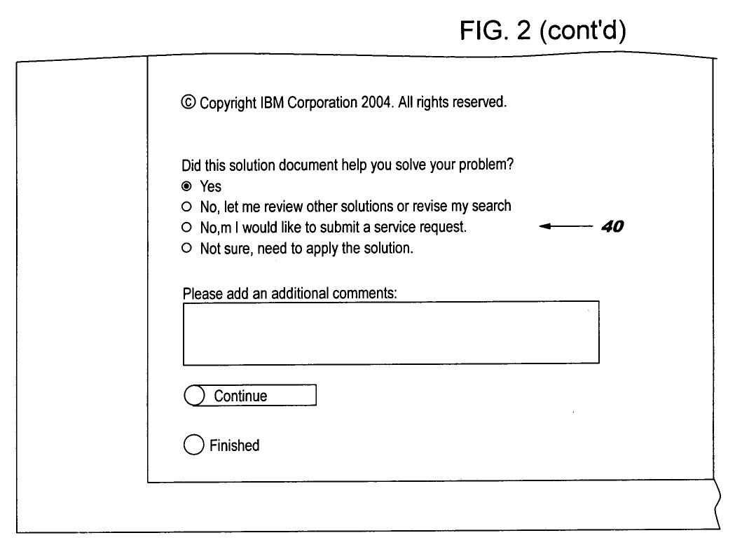

Referring now to FIG. 1, a content search architecture (hereinafter architecture 10) according to the present invention is shown. Under architecture 10, searchable content is maintained (architecturally) separate from displayable content as well as any associated formatting tags. As indicated above, it is typically the case that content which is needed by a search engine to fulfill to a user's search request (i.e., searchable content) is substantially less than what will eventually be displayed to the user (i.e., formatted displayable content). For example, referring to FIG. 2, an illustrative screen shot 30 depicting displayable content 32 that is displayed to a user pursuant to a search request is shown. In general, screen shot 30 represents an illustrative response that is presented when a user has submitted a search request seeking a troubleshooting solution to a printing problem. It should be understood in advance that the manner in which the search request is submitted by the user is not intended to be limiting. For example, the user could submit a natural language or (Boolean logic-based) keyword search request via an interface such as a web browser or help interface. As further known, the search request will be processed by search engine logic 14 (FIG. 1) in an attempt to find an appropriate response. As will be further explained below, architecture 10 of the present invention allows the search to more rapidly processed.

In any event, as shown in FIG. 2, the displayable content 32 not only includes a statement of the problem 34, but also possible solutions 36 as well as related documents 38 and a mechanism 40 for the user to provide feedback. In addition, to make displayable content 32 more user-friendly, various formatting characteristics (e.g., boldfacing, etc.) have been applied thereto. However, in locating the solution for the user, search engine 12 (FIG. 1) really only needs the statement of the problem. That is, in locating the solution, search engine 12 only needs to be able to match language submitted in the user's original search request, which is typically language describing the problem, with content stored in the search engine database 16.

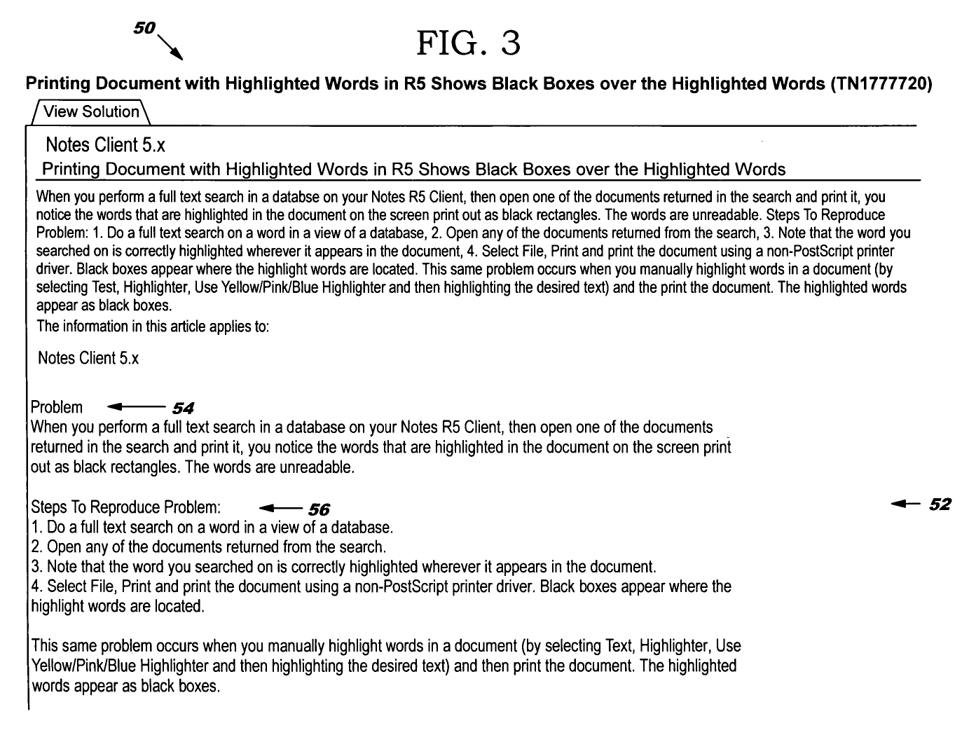

To this extent, referring to FIG. 3, an illustrative screen shot 50 depicting searchable content 52 is shown. As shown, screen shot 50 not only includes less content than screenshot 40 of FIG. 2, but screenshot 50 also lacks the formatting of screenshot 40. Under screenshot 50, searchable content 52 includes only a statement of the problem 54 and possible solutions 56. It should be understood that screen shots 40 and 50 are intended to be illustrative only and other variations exist. For example, searchable content 52 could only include a statement of the problem. Regardless, searchable content 52 should be understood to typically include only a subset of the information of displayable content 32, and contain little or no formatting.

Referring back to FIG. 1, architecture 10 allows searchable content such as that shown in FIG. 3 to be architecturally separated displayable content such as that shown in FIG. 2. To this extent, when content/solutions are initially being provided, a system administrator 22 (or the like) will load only the searchable content to search engine database 16. The corresponding displayable content will be provided to file system 18 for storage in an Extensible Markup Language (XML) file or the like. The formatting tags for formatting the displayable content will then be stored in a style sheet 20 or the like. At that point, the searchable content, the displayable content and the formatting tags are all maintained architecturally separate from one another. However, to make sure these items remain associated with one another, the searchable content will be loaded into search engine database 16 with at least one link pointing to the corresponding displayable content in file system 18. In addition, the displayable content as stored in file system 18 will be associated (as will be further shown below) with the appropriate style sheet 20 so that proper formatting thereof can be ensured.

Thereafter, when a user submits a search request (of search items) to search engine 12, search engine logic 14 will perform a search of search engine database 16 in an attempt to locate appropriate searchable content. As known, this function can be carried out in many ways. For example search engine logic 14 could attempt to match keywords or the like contained in the search request with searchable content contained in the search engine database 16. In any event, because search engine database 16 now includes less content, the search request should be processed considerable faster than with previous systems/architectures. Once the appropriate searchable content has been located, the link(s) stored therewith will be followed by search engine logic 14 to locate the corresponding displayable content in file system 16. Thereafter, the corresponding style sheet 20 will be located, and the formatting tags therein will be used to format the displayable content for display to the user.

II. Computerized Implementation

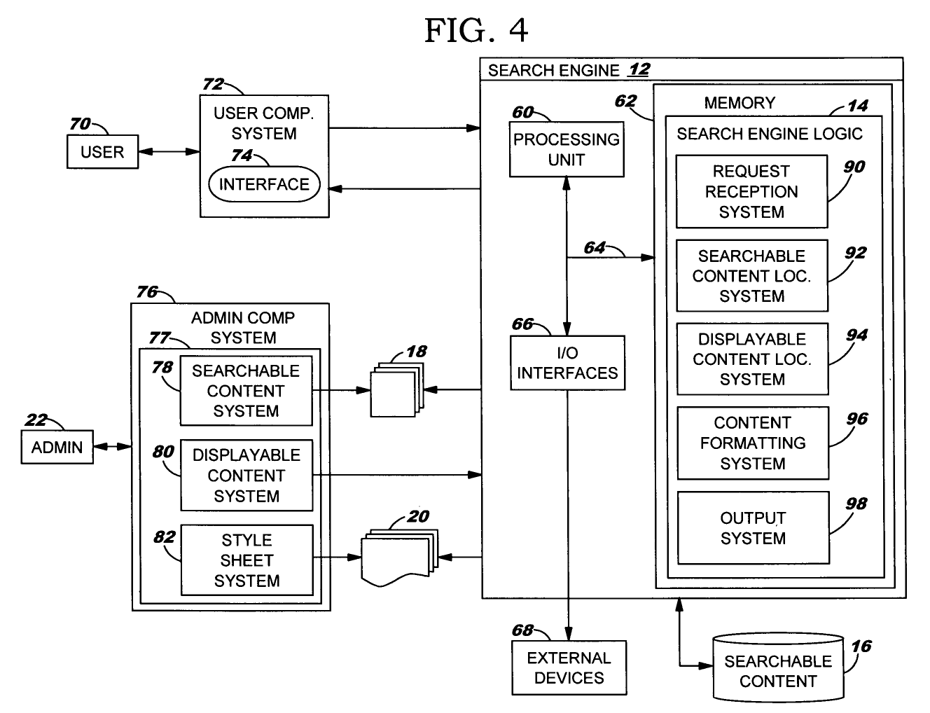

Referring now to FIG. 4, a more detailed diagram of architecture 10 is shown. As depicted, in a typical embodiment, the present invention is realized in a computerized environment. Moreover, it should be appreciated that search engine 12 can be any type of search engine now known or later developed. For example, search engine 12 could be a network-based (e.g., Internet) search engine, etc.

Where search engine 12 is a network-based search engine, user 70 could communicate therewith via a user computer system 72, while system administrator 22 could communicate with search engine 12 via an administrator computer system 76. These computer systems 72 and 76 should be understood to be any type of computerized systems capable of carrying out their respective functions. For example, computer systems 72 and 76 could be desktop computers, workstations, laptop computers, hand held devices, clients, etc. Regardless, the network can be any type of network such as the Internet, a local area network (LAN), a wide area network (WAN), a virtual private network (VPN), etc. To this extent, a direct hardwired connection (e.g., serial port), or an addressable connection with search engine 12 could be implemented. The addressable connection may utilize any combination of wireline and/or wireless transmission methods. Moreover, conventional network connectivity, such as Token Ring, Ethernet, WiFi or other conventional communications standards could be used. Still yet, connectivity could be provided by conventional IP-based protocol.

As also depicted, search engine 12 generally comprises processing unit 60, memory 62, bus 64, input/output (I/O) interfaces 66, external devices/resources 68 and search engine database 16. Processing unit 60 may comprise a single processing unit, or be distributed across one or more processing units in one or more locations, e.g., on a client and server. Memory 62 may comprise any known type of data storage and/or transmission media, including magnetic media, optical media, random access memory (RAM), read-only memory (ROM), a data cache, a data object, etc. Moreover, similar to processing unit 60, memory 62 may reside at a single physical location, comprising one or more types of data storage, or be distributed across a plurality of physical systems in various forms.

I/O interfaces 66 may comprise any system for exchanging information to/from an external source. External devices/resources 68 may comprise any known type of external device, including speakers, a CRT, LED screen, hand-held device, keyboard, mouse, voice recognition system, speech output system, printer, monitor/display, facsimile, pager, etc. Bus 64 provides a communication link between each of the components in search engine 12 and likewise may comprise any known type of transmission link, including electrical, optical, wireless, etc.

Search engine database 16 can be any system capable of providing storage for information under the present invention. Such information could include, among other things, searchable content. As such, search engine database 16 could include one or more storage devices, such as a magnetic disk drive or an optical disk drive. In another embodiment, search engine database 16 includes data distributed across, for example, a local area network (LAN), wide area network (WAN) or a storage area network (SAN) (not shown).

Although not shown, additional components, such as cache memory, communication systems, system software, etc., may be incorporated into search engine 12. Moreover, it should be understood that user computer system 72 and administrator computer system 76 will likely include computerized components similar to search engine 12.

As explained above, searchable content, displayable content and formatting tags are maintained architecturally separate from one another under the present invention. To this extent, shown loaded on administrator computer system 76 is content system 77, which can incorporate components of any known system for providing content to a search engine 12. Under the present invention, when system administrator 22 wishes to submit content for searching by user 70, he/she will utilize (1) searchable content system 78 to load searchable content to search engine 12 (i.e., to search database 16); (2) displayable content system 80 to store the corresponding displayable content in file system 18; and (3) style sheet system 82 to store formatting tags for formatting the displayable content in a style sheet 20. As mentioned above, the searchable content will be stored with links that point to the corresponding displayable content in file system 18 (e.g., the associated XML file). Such links can be stored by either searchable content system 78, displayable content system 80 or by another system not shown in FIG. 4. Moreover, in a typical embodiment, the displayable content will be stored in an XML file or the like that references the style sheet. An example of an illustrative XML file is shown below:

<?xml version=“1.0” encoding=“ISO-8859-1” ?>
−<SOLUTION>
<TITLE>Printing Document with Highlighted Words in R5 Shows Black

Boxes over the Highlighted Words</TITLE>

<DESCRIPTION>When you perform a full text search in a database on

your Notes R5 Client, then open one of the documents returned in the search and
print it, you notice the words that are highlighted in the document on the screen
print out as black rectangles. The words are unreadable.</DESCRIPTION>

<DATE_CREATED

isodt=“19960823T00:00:00”>8/23/1996</DATE_CREATED>

<DATE_MODIFIED

isodt=“20001109T12:12:00”>11/9/2000</DATE_MODIFIED>

```
  <TYPE>Technote</TYPE>
  <SOLUTION_ID majorver=“1” minorver=“0”
```

legacyid=“TN177726”>177726</SOLUTION_ID>

```
  <LANGUAGE encoding=“Iso88591”>enus</LANGUAGE>
  <SECURITY secdata=“yes”>public</SECURITY>
−<METADATA>
−<APPLIES_TO>
  <E id=“APPLIES_TO_SECTION”>The information in this article applies
```

to:</E>

```
−<PRODUCT id=“1111”>
  <PRODUCT_NAME>Notes Client 4.x</PRODUCT_NAME>
  </PRODUCT>
  </APPLIES_TO>
−<COPYRIGHT>
  <COPYRIGHT_WW> ©2002 IBM.</COPYRIGHT_WW>
  <COPYRIGHT_LOC>All rights reserved.</COPYRIGHT_LOC>
  </COPYRIGHT>
  </METADATA>
−<SECTION type=“problem”>
−<SECTIONHEADING>
  <E id=“STATUS_SECTION”>PROBLEM</E>
  </SECTIONHEADING>
  <SECTIONBODY>When you perform a full text search in a database on
```

your Notes R5 Client, then open one of the documents returned in the search and
print it, you notice the words that are highlighted in the document on the screen
print out as black rectangles. The words are unreadable. Steps To Reproduce
Problem: 1. Do a full text search on a word in a view of a database. 2. Open any of
the documents returned from the search. 3. Note that the word you searched on is
correctly highlighted wherever it appears in the document. 4. Select File, Print and
print the document using a non-PostScript printer driver. Black boxes appear
where the highlight words are located. This same problem occurs when you
manually highlight words in a document (by selecting Text, Highlighter, Use
Yellow/Pink/Blue Highlighter and then highlighting the desired text) and then print
the document. The highlighted words appear as black boxes.</SECTIONBODY>

```
  </SECTION>
−<SECTION type=“solution”>
−<SECTIONHEADING>
  <E id=“STATUS_SECTION”>SOLUTION</E>
  </SECTIONHEADING>
  <SECTIONBODY>This issue has been reported to Lotus Quality
```

Engineering. The issue occurs when printing using a non-PostScript printer driver
(for example: ‘HP LaserJet 5P’). The issue does not occur when using a PostScript
printer driver (for example: ‘HP LaserJet 5P/5MP PostScript’). Workarounds for
Full Text Search Issue (spr #s: TBOO457PMU, JWAG46BFEC) : 1. In the search
results at the view level, select the specific document you need to print, reset the
search (by selecting the Clear Results button on the search bar) and then print the
document. The search boxes will be gone after resetting the search. The words you
searched on will print so that you can see them, or 2. Print using a PostScript
printer driver. This will enable you to read the searched words, because the shading
on them is very light when printing with the PostScript driver. Note: R5 prints
search results the same way as they appear on the screen (as a fill pattern behind the
text). In R4, search results appeared with a thin black rectangular line surrounding
the words. This change in functionality is by design. Workaround for Highlighter
Issue (spr #GRY49UT3J): 1. You can print using a PostScript printer driver. While
this will allow you to read the text, it will also prevent you from seeing the
highlighter at all. The highlight effect lightens up so much, you can barely see
it.</SECTIONBODY>

```
  </SECTION>
−<SECTION type=“related”>
−<SECTIONHEADING>
  <E id=“RELATED_DOCS_SECTION”>RELATED DOCUMENTS</E>
  </SECTIONHEADING>
  <SECTIONBODY>Mail Memo With Colored Text Sent From a Web
```

Browser Reverts to Black Text When Memo is Sent Document #:
179760</SECTIONBODY>

```
  </SECTION>
  </SOLUTION>
```

In providing these functions, content system 77 should be understood to include all interfaces and functionality necessary to architecturally separate the searchable content, the displayable content and the formatting tags, as well as to provide all necessary links, references, etc. To this extent, it should be understood that the depiction of content system 77 of FIG. 4 is intended to be illustrative only and that many variations could be implemented. For example, all three subsystems 78, 80 and 82 could be provided as a single system. Still yet, additional functionality could be provided. For example, administrator 22 need not submit the searchable content. Rather searchable content system 78 could include logic/algorithms for filtering any displayable content provided by system administrator 22 (e.g., reduce the content and remove formatting) to yield corresponding searchable content.

Regardless, once the searchable content, displayable content and formatting tags have been provided, a user 70 is free to conduct a search thereof. Accordingly, assume that user 70 submits a search request of search items (e.g., natural language words) via user interface 74 (e.g., a web browser). The search request will be received by request reception system 90 of search engine logic 14. Thereafter, searchable content location system 92 will utilize the search items to locate appropriate searchable content (i.e., searchable content that best fulfills the search request). Once located, displayable content location system 94 will follow the link(s) stored with the located searchable content to locate the corresponding displayable content in file system 18. Thereafter, content formatting system 96 will access/retrieve the style sheet 20 associated with the displayable content, and use the formatting tags there to format the displayable content as needed. Once formatted, the displayable content will then be outputted to user 70 by output system (e.g., for display in interface 74).

It should be appreciated that the teachings of the present invention could be offered as a business method on a subscription or fee basis. For example, search engine 12 or administrator system 76 could be created, maintained, supported and/or deployed by a service provider that offers the functions described herein for customers.

It should also be understood that the present invention can be realized in hardware, software, a propagated signal, or any combination thereof. Any kind of computer/server system(s)—or other apparatus adapted for carrying out the methods described herein—is suited. A typical combination of hardware and software could be a general purpose computer system with a computer program that, when loaded and executed, carries out the respective methods described herein. Alternatively, a specific use computer, containing specialized hardware for carrying out one or more of the functional tasks of the invention, could be utilized. The present invention can also be embedded in a computer program product or a propagated signal, which comprises all the respective features enabling the implementation of the methods described herein, and which—when loaded in a computer system—is able to carry out these methods. Computer program, propagated signal, software program, program, or software, in the present context mean any expression, in any language, code or notation, of a set of instructions intended to cause a system having an information processing capability to perform a particular function either directly or after either or both of the following: (a) conversion to another language, code or notation; and/or (b) reproduction in a different material form.

The foregoing description of the preferred embodiments of this invention has been presented for purposes of illustration and description. It is not intended to be exhaustive or to limit the invention to the precise form disclosed, and obviously, many modifications and variations are possible. Such modifications and variations that may be apparent to a person skilled in the art are intended to be included within the scope of this invention as defined by the accompanying claims. For example, the depiction of search engine logic 14 of FIG. 4 is intended to be illustrative only.

We claim:

1. A content searching method, comprising:
loading searchable content into a search engine;
storing displayable content corresponding to the searchable content in a file system that is separate from the search engine, wherein the searchable content loaded into the search engine includes at least one link pointing to the displayable content in the file system; and
providing formatting tags for formatting the displayable content in a style sheet.

2. The content searching method of claim 1, further comprising providing searchable content corresponding to searchable items prior to the loading step.

3. The content searching method of claim 1, further comprising:
receiving a search request;
locating the searchable content in the search engine based on the search request;
locating the displayable content in the file system using the at least one link;
formatting the displayable content using the formatting tags in the style sheet; and
displaying the displayable content after the formatting step.

4. The content searching method of claim 1, wherein the searchable content is loaded into a database of the search engine, and wherein the file system is architecturally separate from the database.

5. The content searching method of claim 1, wherein the displayable content is stored within a specific file in the file system, and wherein the specific file references the style sheet.

6. The content searching method of claim 5, wherein the specific file is an Extensible Markup Language (XML) file.

7. The content searching method of claim 1, wherein the searchable content contains a subset of information contained in the displayable content.

8. A content searching architecture, comprising:
a search engine having searchable content corresponding to searchable items;
a file system separate from the search engine having displayable content corresponding to the searchable content, wherein the searchable content is associated with the displayable by at least one link; and
a style sheet containing formatting tags for formatting the displayable content.

9. The content searching architecture of claim 8, wherein the searchable content is loaded into a database of the search engine, and wherein the file system is architecturally separate from the database.

10. The content searching architecture of claim 8, wherein the displayable content is stored within a specific file in the file system, and wherein the specific file references the style sheet.

11. The content searching architecture of claim 10, wherein the specific file is an Extensible Markup Language (XML) file.

12. The content searching architecture of claim 8, wherein the searchable content contains a subset of information contained in the displayable content.

13. A content searching system, comprising:
a searchable content location system for locating searchable content in a search engine database based on a search request;
a displayable content location system for locating displayable content corresponding to the searchable content in a file system based on at least one link that associates the searchable content with the displayable content, wherein the file system is separate from the search engine database;
a content formatting system for formatting the displayable content based on formatting tags contained in a style sheet associated with the displayable content; and
an output system for outputting the displayable content after the formatting.

14. The content searching system of claim 13, further comprising a request reception system for receiving the search request.

15. The content searching system of claim 13, wherein the displayable content is stored within a specific file in the file system, and wherein the specific file references the style sheet.

16. The content searching system of claim 15, wherein the specific file is an Extensible Markup Language (XML) file.

17. The content searching system of claim 13, wherein the searchable content contains a subset of information contained in the displayable content.

18. The content searching system of claim 13, further comprising:
a displayable content system for storing the displayable content in the file system;
a searchable content system for loading the searchable content into the search engine database; and
a style sheet system for storing the formatting tags in the style sheet.

19. The content searching system of claim 13, wherein the searchable content system further filters the displayable content to yield the searchable content.

20. A content searching program product stored on a recordable medium, which when executed, comprises:
program code for locating searchable content in a search engine database based on a search request;
program code for locating displayable content corresponding to the searchable content in a file system based on at least one link that associates the searchable content with the displayable content, wherein the file system is separate from the search engine database;
program code for formatting the displayable content based on formatting tags contained in a style sheet associated with the displayable content; and
program code for outputting the displayable content after the formatting.

21. The content searching program product of claim 20, further comprising program code for receiving the search request.

22. The content searching program product of claim 20, wherein the displayable content is stored within a specific file in the file system, and wherein the specific file references the style sheet.

23. The content searching program product of claim 22, wherein the specific file is an Extensible Markup Language (XML) file.

24. The content searching program product of claim 20, wherein the searchable content contains a subset of information contained in the displayable content.

25. The content searching program product of claim 20, further comprising:
program code for storing the displayable content in the file system;
program code for loading the searchable content into the search engine database; and
program code for storing the formatting tags in the style sheet.

26. The content searching program product of claim 20, wherein the program code for loading the searchable content further filters the displayable content to yield the searchable content.

27. A system for deploying a content searching application, comprising:
a computer infrastructure being operable to:
locate searchable content in a search engine database based on a search request;
locate displayable content corresponding to the searchable content in a file system based on at least one link that associates the searchable content with the displayable content, wherein the file system is separate from the search engine database;
format the displayable content based on formatting tags contained in a style sheet associated with the displayable content; and
output the displayable content after the formatting.

28. Content searching computer software embodied in a propagated signal, the content searching computer software comprising instructions for causing a computer system to perform the following functions:
locate searchable content in a search engine database based on a search request;
locate displayable content corresponding to the searchable content in a file system based on at least one link that associates the searchable content with the displayable content, wherein the file system is separate from the search engine database;
format the displayable content based on formatting tags contained in a style sheet associated with the displayable content; and
output the displayable content after the formatting.
